(19) United States
(12) Patent Application Publication
(10) Pub. No.: US 2025/0367756 A1
(43) Pub. Date: Dec. 4, 2025

(54) LASER PROCESSING APPARATUS AND LASER BEAM APPLYING METHOD

(71) Applicant: DISCO CORPORATION, Tokyo (JP)

(72) Inventors: Haruki KAMIYAMA, Tokyo (JP); Kazuhiko IDA, Tokyo (JP); Nobuyuki KIMURA, Tokyo (JP)

(21) Appl. No.: 19/211,567

(22) Filed: May 19, 2025

(30) Foreign Application Priority Data
May 28, 2024 (JP) 2024-086475

(51) Int. Cl. B23K 26/06

(52) U.S. Cl. CPC B23K 26/0643

(57) ABSTRACT

A laser processing apparatus includes a laser oscillator for emitting a laser beam, a polygon mirror having a plurality of reflective facets and rotatable for scanning the laser beam, a beam condenser for focusing the laser beam scanned by the polygon mirror, a position adjusting unit for adjusting irradiated positions where the reflective facets are irradiated with the laser beam, and a measuring unit for measuring the positions of irradiated regions that are irradiated with the laser beam scanned by the polygon mirror, in which the position adjusting unit adjusts the irradiated positions where the reflective facets are irradiated with the laser beam with respect to the respective reflective facets on the basis of the positions of the irradiated regions measured by the measuring unit with respect to the respective reflective facets.

### BACKGROUND OF THE INVENTION

### Field of the Invention

The present invention relates to a laser processing apparatus that scans a laser beam with a polygon mirror and a laser beam applying method that applies a laser beam to a plurality of reflective facets of a polygon mirror.

### Description of the Related Art

Device chip fabrication processes work on wafers where devices are present in respective areas demarcated by a grid of streets also known as projected dicing lines. Such a wafer is divided along the streets into individual pieces as device chips including respective devices. The device chips will be incorporated in various electronic appliances such as cellular phones and personal computers, for example.

Cutting apparatuses for cutting workpieces with annular cutting blades are used to divide wafers. In recent years, there has been developed a process of dividing a wafer with a laser beam on a laser processing apparatus. The laser processing apparatus includes a holding table for holding a workpiece such as a wafer thereon and a laser beam applying unit for applying a laser beam to the workpiece. The laser beam applying unit includes an optical system for optically guiding the laser beam toward the workpiece. The optical system has various optical components such as mirrors and lenses, for example. The laser beam applying unit irradiates the workpiece with a laser beam that is absorbable by the workpiece, thereby processing the workpiece by way of ablation to divide the workpiece.

When a region of the workpiece is irradiated with the laser beam, the irradiated region produces a melted substance called debris. Then, the produced debris is solidified again, i.e., backfills or is recast in the irradiated region, tending to present an obstacle to an efficient application of the laser beam. In view of the drawback, there has been proposed in the art a process of scanning a laser beam repeatedly in a number of cycles at a high speed using a polygon mirror incorporated in the optical system of the laser beam applying unit (see, for example, Japanese Patent Laid-open No. 2019-51536). The proposed process makes it possible to process a workpiece with a laser beam while preventing a melted substance from being solidified again, resulting in an increase in the efficiency with which to process the workpiece with the laser beam.

### SUMMARY OF THE INVENTION

The polygon mirror incorporated in the optical system of the laser beam applying unit is shaped as a polygonal prism having a plurality of reflective facets or mirror facets. When a laser beam is applied to the polygon mirror that is rotating at a high speed about is central axis, the laser beam is reflected and scanned by the reflective facets whose angles vary continuously with respect to the laser beam. As the laser beam is applied to the reflective facets successively one after another upon rotation of the polygon mirror, the laser beam repeatedly scans a region of the workpiece in a number of cycles.

Ideally, the polygon mirror should be shaped as a regular polygonal prism such that all the reflective facets lie parallel to the central axis about which the polygon mirror rotates. Actually, however, it is difficult to keep all the reflective facets parallel to the central axis due to polygon mirror fabrication process errors, and the angles of the reflective facets with respect to the central axis are slightly different from each other. As a consequence, the direction in which the laser beam is reflected from the polygon mirror varies in each of the reflective facets, causing the laser beam to be applied to unintended regions of the workpiece.

In view of the above problem, it is an object of the present invention to provide a laser processing apparatus and a laser beam applying method that are capable of appropriately scanning a laser beam with a polygon mirror.

In accordance with an aspect of the present invention, there is provided a laser processing apparatus including a laser oscillator for emitting a laser beam, a polygon mirror having a plurality of reflective facets and rotatable for scanning the laser beam, a beam condenser for focusing the laser beam scanned by the polygon mirror, a position adjusting unit for adjusting irradiated positions where the reflective facets are irradiated with the laser beam, and a measuring unit for measuring the positions of irradiated regions that are irradiated with the laser beam scanned by the polygon mirror, in which the position adjusting unit adjusts the irradiated positions where the reflective facets are irradiated with the laser beam with respect to the respective reflective facets on the basis of the positions of the irradiated regions measured by the measuring unit with respect to the respective reflective facets.

In accordance with another aspect of the present invention, there is provided a laser beam applying method of applying a laser beam to a plurality of reflective facets of a polygon mirror, including measuring positions of irradiated regions that are irradiated with the laser beam scanned by the polygon mirror with respect to the respective reflective facets, and while the laser beam is being applied to the reflective facets, adjusting irradiated positions where the reflective facets are irradiated with the laser beam with respect to the respective reflective facets on the basis of the positions of the irradiated regions, which have been measured in the measuring.

With the laser processing apparatus and the laser beam applying method according to the aspects of the present invention, the irradiated positions where the reflective facets of the polygon mirror are irradiated with the laser beam are adjusted with respect to the respective reflective facets. Therefore, even in the presence of angle variations of the reflective facets, the laser beam can be appropriately scanned by the polygon mirror.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view, partly in block form, of a laser processing apparatus according to an embodiment of the present invention;

FIG. 2 is a perspective view of a workpiece;

FIG. 3 is a front elevational view, partly in block form, schematically illustrating a laser beam applying unit;

FIG. 4 is a perspective view illustrating an example of a polygon mirror and an irradiated facet specifying unit;

FIG. 5 is a perspective view illustrating another example of the polygon mirror and the irradiated facet specifying unit;

FIG. 6 is a front elevational view of the laser beam applying unit and a measuring unit;

FIG. 7 is a flowchart of a laser beam applying method according to the embodiment of the present invention;

FIG. 8 is a perspective view, partly in block form, of the laser processing apparatus while it is carrying out the laser beam applying method; and

FIG. 9 is a perspective view, partly in block form, of an irradiated facet specifying unit according to a modification.

### DETAILED DESCRIPTION OF THE PREFERRED EMBODIMENT

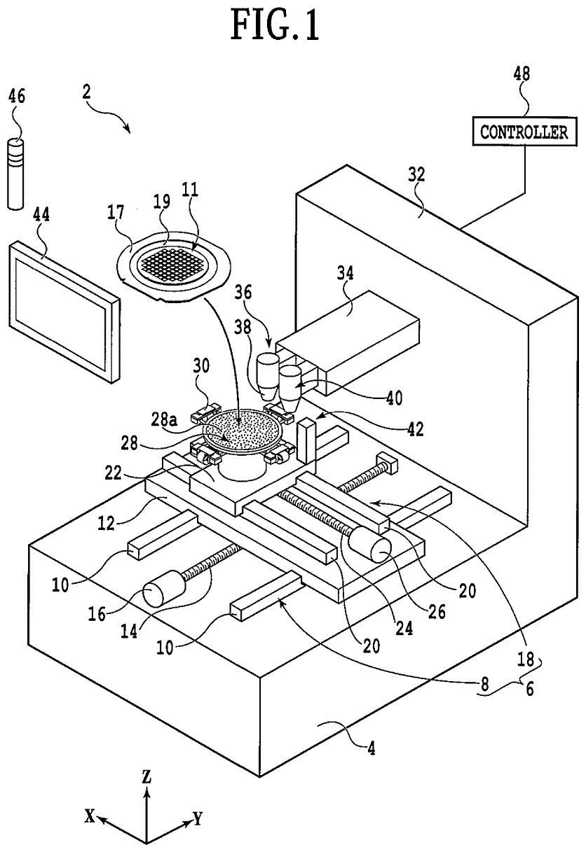

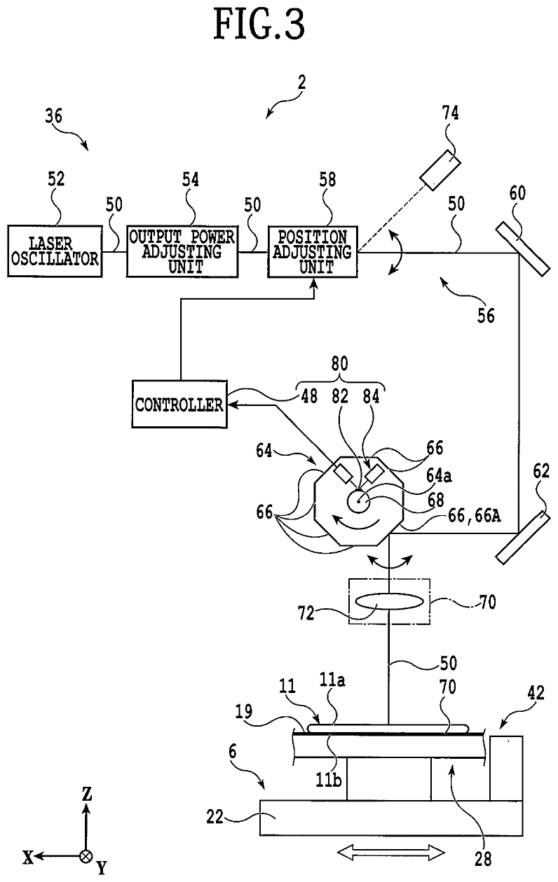

A preferred embodiment of the present invention will be described hereinbelow with reference to the accompanying drawings. First, a laser processing apparatus according to an embodiment of the present invention will be described below. FIG. 1 illustrates in perspective, partly in block form, the laser processing apparatus, denoted by 2, that processes a workpiece 11 with a laser beam. In FIG. 1, the laser processing apparatus 2 is illustrated in reference to a three-dimensional coordinate system having an X-axis indicated by the arrow X, a Y-axis indicated by the arrow Y, and a Z-axis indicated by the arrow Z. The X-axis represents processing feed directions, first horizontal directions, or leftward and rightward directions. The Y-axis represents indexing feed directions, second horizontal directions, or forward and rearward direction. The Z-axis represents upward and downward directions, heightwise directions, and vertical directions. The X-axis, the Y-axis, and the Z-axis defined as described above are also illustrated in FIGS. 3, 4, 5, 6, 8, and 9. For the sake of convenience, the left end, as viewed in FIG. 1, of the laser processing apparatus 2 will be referred to as a front end, and the right end thereof as a rear end. Some directional expressions such as front, rear, forward, and rearward will be used in accord with the front and rear ends of the laser processing apparatus 2. Other directional expressions such as upper, lower, upward, downward, left, right, leftward, and rightward will be used in accord with directions as viewed in FIG. 1.

The laser processing apparatus 2 includes a base 4 that supports thereon components of the laser processing apparatus 2. An upper surface of the base 4 is a flat upper surface essentially parallel to a horizontal plane, i.e., an XY plane, and the laser processing apparatus 2 has a moving assembly 6 disposed on an upper surface of the base 4. The moving assembly 6 includes a Y-axis moving unit or mechanism 8 and an X-axis moving unit or mechanism 18.

The Y-axis moving unit 8 includes a pair of Y-axis guide rails 10 mounted on the upper surface of the base 4 and extending along the Y-axis. The Y-axis moving unit 8 also includes a Y-axis movable table 12 shaped as a flat plate slidably mounted on the Y-axis guide rails 10 for sliding movement along the Y-axis, i.e., the Y-axis guide rails 10. A nut, not depicted, is disposed on a reverse side, i.e., a lower surface, of the Y-axis movable table 12. The nut is operatively threaded over a Y-axis ball screw 14 rotatably disposed between the Y-axis guide rails 10 and extending along the Y-axis. The Y-axis ball screw 14 has an axial end coupled to a Y-axis stepping motor 16. When the Y-axis stepping motor 16 is energized, it rotates the Y-axis ball screw 14 about its longitudinal central axis, causing the nut and hence the Y-axis movable table 12 to slidingly move along the Y-axis guide rails 10.

The X-axis moving unit 18 includes a pair of X-axis guide rails 20 mounted on a face side, i.e., an upper surface, of the Y-axis movable table 12 and extending along the X-axis. The X-axis moving unit 18 also includes an X-axis movable table 22 shaped as a flat plate slidably mounted on the X-axis guide rails 20 for sliding movement along the X-axis, i.e., the X-axis guide rails 20. A nut, not depicted, is disposed on a reverse side, i.e., a lower surface, of the X-axis movable table 22. The nut is operatively threaded over an X-axis ball screw 24 rotatably disposed between the X-axis guide rails 20 and extending along the X-axis. The X-axis ball screw 24 has an axial end coupled to an X-axis stepping motor 26. When the X-axis stepping motor 26 is energized, it rotates the X-axis ball screw 24 about its longitudinal central axis, causing the nut and hence the X-axis movable table 22 to slidingly move along the X-axis guide rails 20.

The moving assembly 6 supports a holding table, i.e., a chuck table, 28, thereon. The holding table 28 is mounted on a face side, i.e., an upper surface, of the X-axis movable table 22 for holding thereon the workpiece 11 that is a target object to be processed with the laser beam on the laser processing apparatus 2.

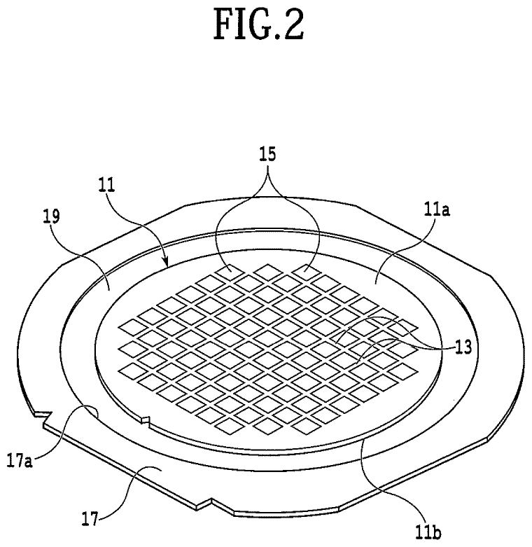

FIG. 2 illustrates the workpiece 11 in perspective. According to the present embodiment, the workpiece 11 includes a disk-shaped wafer, for example, made of a semiconductor material such as monocrystalline silicon, for example, and has a face side 11a and a reverse side 11b that lie opposite each other and extend essentially parallel to each other. The workpiece 11 has a plurality of rectangular areas demarcated by a grid of intersecting streets or projected dicing lines 13. Devices 15 such as integrated circuits (ICs), large-scale integration (LSI) circuits, light-emitting diodes (LEDs), or microelectromechanical systems (MEMS) devices constructed respectively in the demarcated areas on the face side 11a. According to the present invention, the workpiece 11 is not limited to any particular types, materials, shapes, structures, and sizes, for example. The workpiece 11 may include a substrate or wafer made of any of semiconductors other than silicon, e.g., gallium arsenide (GaAs), indium phosphorus (InP), gallium nitride (GaN), or silicon carbide (Sic), sapphire, glass, ceramic, resin, or metal, for example. The devices 15 are not limited to any particular types, numbers, shapes, structures sizes, and layouts, for example. The workpiece 11 may even be free of the devices 15.

When the workpiece 11 is processed on the laser processing apparatus 2 (see FIG. 1), the workpiece 11 is supported on an annular frame 17 for easy handling upon being delivered or held, for example. The frame 17 is made of a metal material such as stainless steel (SUS), for example. The frame 17 has a circular opening 17a defined centrally therein and extending through the frame 17 thicknesswise. The opening 17a is larger in diameter than the workpiece 11.

A circular sheet 19 is secured to the workpiece 11 and the frame 17. The sheet 19 includes a tape, for example, including a circular film-shaped base and an adhesive layer, i.e., a glue layer, disposed on the base. The base is made of resin such as polyolefin, polyvinyl chloride, or polyethylene terephthalate, for example. The adhesive layer is made of an epoxy-based, acryl-based, or rubber-based adhesive, for example. The adhesive layer may alternatively be made of an ultraviolet-curable resin.

The sheet 19 has a central portion affixed to the reverse side 11b of the workpiece 11 disposed in the opening 17a in the frame 17 and an outer circumferential portion affixed to a lower surface of the frame 17. The workpiece 11 is thus supported on the frame 17 by the sheet 19.

As illustrated in FIG. 1, the holding table 28 has a flat upper surface lying essentially parallel to a horizontal plane, i.e., an XY plane defined by the X-axis and the Y-axis. The upper surface of the holding table 28 acts as a holding surface 28a for holding the workpiece 11 thereon. The holding surface 28a is fluidly connected to a suction source, not depicted, such as an ejector, for example, via a fluid channel, not depicted, defined in the holding table 28 and a valve, not depicted. A plurality of clamps 30 for gripping and securing the frame 17 in place are disposed at spaced intervals around the holding table 28.

When the Y-axis moving unit 8 moves the Y-axis movable table 12 along the Y-axis, the holding table 28 is moved along the Y-axis. When the X-axis moving unit 18 moves the X-axis movable table 22 along the X-axis, the holding table 28 is moved along the X-axis. The holding table 28 is coupled to a rotary actuator, not depicted, such as an electric motor for rotating the holding table 28 about its vertical central axis essentially parallel to the Z-axis. When the rotary actuator is energized, it rotates the holding table 28 about its vertical central axis.

The laser processing apparatus 2 includes a cuboid support structure 32 at the rear end of the base 4 behind the moving assembly 6 and the holding table 28. The support structure 32 protrudes upwardly from the upper surface of the base 4 and has a front surface extending along an XZ plane defined by the X-axis and the Z-axis. A columnar support arm 34 protrudes forwardly from the front surface of the support structure 32.

The laser processing apparatus 2 includes a laser beam applying unit 36 for applying a laser beam to the workpiece 11. The laser beam applying unit 36 includes a laser processing head 38 mounted on a distal end of the support arm 34 remote from the support structure 32 above the holding table 28. When the laser processing head 38 is in operation, it emits and applies a laser beam to the workpiece 11 held on the holding table 28, to process the workpiece 11 with the laser beam.

An image capturing unit 40 for capturing images of the workpiece 11 held on the holding table 28 is also mounted on the distal end of the support arm 34 adjacent to the laser beam applying unit 36. The image capturing unit 40 includes an image sensor such as a charge-coupled device (CCD) sensor or a complementary metal-oxide-semiconductor (CMOS) sensor, for example, that captures images of the workpiece 11 held on the holding table 28. According to the present invention, the image capturing unit 40 is not limited to any particular types, and may alternatively include a visible-light camera or an infrared camera. The workpiece 11 and the laser processing head 38 are positioned with respect to the other, the state of the workpiece 11 is confirmed, and the processed result of the workpiece 11 is evaluated on the basis of images captured of the workpiece 11 by the image capturing unit 40.

The support arm 34 may be connected to the support structure 32 by a Z-axis moving unit or mechanism, not depicted, for moving the support arm 34 along the Z-axis. For example, the Z-axis moving unit may include a ball-screw-type moving unit mounted on the front surface of the support structure 32. When the Z-axis moving unit is actuated, it may move the support arm 34 along the Z-axis, adjusting the vertical position of the focused spot of the laser beam emitted from the laser processing head 38 and/or focusing the image capturing unit 40.

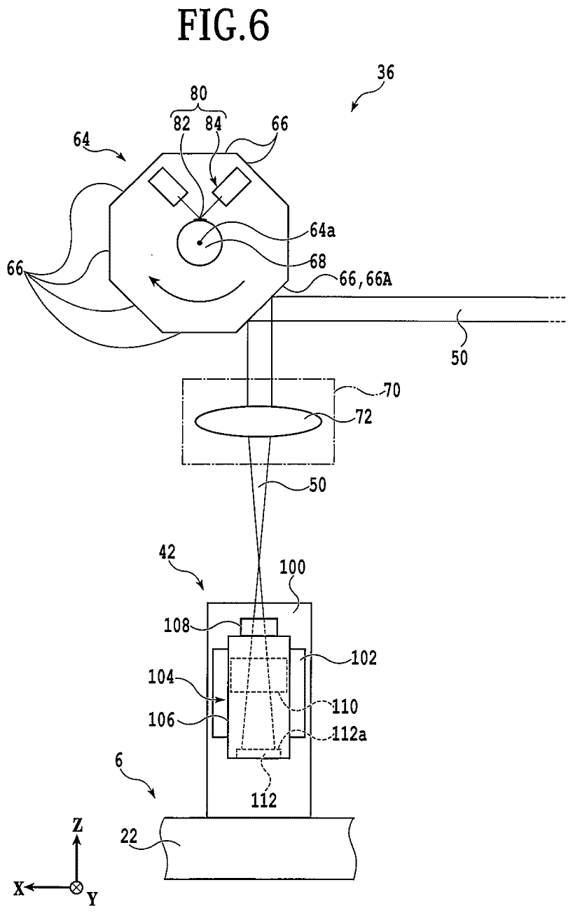

The laser processing apparatus 2 further includes a measuring unit 42 for measuring the position of a region irradiated with a laser beam. The measuring unit 42 detects the laser beam applied from the laser beam applying unit 36 and detects a position where the laser beam is applied. For example, the measuring unit 42 is mounted on the X-axis movable table 22 and thus coupled to the moving assembly 6, i.e., the Y-axis moving unit 8 and the X-axis moving unit 18. The measuring unit 42 can be moved along the X-axis and the Y-axis by the moving assembly 6. Structural and functional details of the measuring unit 42 and the way in which the measuring unit 42 is used will be described later with reference to FIG. 6.

Moreover, the laser processing apparatus 2 includes a display unit, i.e., a display section or display device, 44 for displaying various pieces of information regarding the laser processing apparatus 2. The display unit 44 includes a touch panel, for example. The touch panel as the display unit 44 displays an operation screen for entering information into the laser processing apparatus 2. Specifically, an operator enters information into the laser processing apparatus 2 by touching the touch panel with a finger. Therefore, the touch panel functions as an input unit, i.e., an input section or an input device, for entering various pieces of information into the laser processing apparatus 2, and is used as a user interface. However, an input unit such as a mouse or a keyboard, for example, that is independent of the display unit 44 may alternatively be included in the laser processing apparatus 2.

The laser processing apparatus 2 also includes a reporting unit, i.e., a reporting section or a reporting device, 46 for reporting information to the operator. For example, the reporting unit 46 includes an indicator lamp, i.e., a warning lamp, that is turned on or blinks to indicate an error to the operator when the laser processing apparatus 2 malfunctions. However, the reporting unit 46 is not limited to any particular types. For example, the reporting unit 46 may include a speaker for giving information to the operator by way of sound or speech, or a transmitter for transmitting information to the outside of the laser processing apparatus 2.

Moreover, the laser processing apparatus 2 includes a controller, i.e., a control unit, a control section, or a control device, 48 for controlling the laser processing apparatus 2. The controller 48 is electrically connected to various components, e.g., the moving assembly 6, the holding table 28, the clamps 30, the laser beam applying unit 36, the image capturing unit 40, the measuring unit 42, the display unit 44, and the reporting unit 46, of the laser processing apparatus 2. The controller 48 outputs control signals to the components of the laser processing apparatus 2 to operate the laser processing apparatus 2. The controller 48 includes a computer, for example. Specifically, the controller 48 includes a processing unit for carrying out processing operations such as arithmetic operations required to operate the laser processing apparatus 2 and a storage unit for storing various pieces of information such as data and programs that are used to operate the laser processing apparatus 2. The processing unit includes a processor such as a central processing unit (CPU). The storage unit includes memories such as a read only memory (ROM) and a random access memory (RAM).

For processing the workpiece 11 with a laser beam on the laser processing apparatus 2, first, the workpiece 11 is held on the holding table 28. Specifically, for example, the workpiece 11 is placed on the holding table 28 such that the face side 11a is exposed upwardly and the reverse side 11b, i.e., the sheet 19, faces the holding surface 28a. The frame 17 that supports the workpiece 11 via the sheet 19 is secured in place by the clamps 30. Then, the suction source fluidly connected to the holding surface 28a is actuated to apply a suction force, i.e., a negative pressure, to the holding surface 28a, thereby holding the workpiece 11 under suction on the holding table 28 with the sheet 19 interposed therebetween.

Then, the laser beam applying unit 36 is energized to apply a laser beam from the laser processing head 38 to the workpiece 11 on the holding table 28, thereby processing the workpiece 11 with the laser beam. Conditions for applying the laser beam to the workpiece 11 are established depending on the details of a laser processing process to be performed on the workpiece 11. For example, laser beam applying conditions are established to perform an ablating process on the workpiece 11. Specifically, the laser beam is of a wavelength selected to cause at least part of the laser beam to be absorbed by the workpiece 11. That is, the laser beam having absorbability with respect to the workpiece 11 is used. The other laser beam applying conditions are established to perform the ablating process appropriately on the workpiece 11. For example, in a case where the workpiece 11 is a monocrystalline silicon wafer, the laser beam applying conditions are established as follows:
Wavelength: 355 nm
Average output power: 2 W
Repetitive frequency: 200 kHz
Processing feed speed: 400 mm/s

When the laser beam is to be applied to the workpiece 11, the holding table 28 that is holding the workpiece 11 is turned about its vertical central axis to orient a group of certain streets 13 such that their longitudinal directions extend parallel to the X-axis. Moreover, the position of the holding table 28 along the Y-axis is adjusted to bring the position of the focused spot of the laser beam into alignment with a target one of those certain streets 13 along the Y-axis. Then, while the laser processing head 38 is applying the laser beam to the workpiece 11, the holding table 28 is moved, i.e., processing-fed, along the X-axis. The holding table 28 and the laser processing head 38 are now moved relatively to each other along the X-axis, so that the laser beam is applied to the workpiece 11 along the target street 13. The above process is repeated to apply the laser beam to the workpiece 11 along other streets 13 until the workpiece 11 is irradiated with the laser beam along all of the streets 13.

When the laser beam is applied to the workpiece 11 as described above, the workpiece 11 is ablated along the streets 13, forming laser-processed grooves in the workpiece 11 that extend therethrough from the face side 11a to the reverse side 11b along the streets 13. The workpiece 11 is now divided into a plurality of individual pieces as device chips that include the respective devices 15 (see FIG. 2). If it is difficult to fully divide the workpiece 11 in one session of applying the laser beam to the workpiece 11 along all of the streets 13, then the laser beam may be applied in a plurality of sessions to the workpiece 11 along each of the streets 13.

The laser beam may be applied to the workpiece 11 to process the workpiece 11 in different manners. For example, the laser beam may be applied to the workpiece 11 to form laser-processed grooves in the workpiece 11 that do not extend therethrough from the face side 11a to the reverse side 11b along the streets 13, i.e., that have a depth smaller than the thickness of the workpiece 11. Alternatively, the laser beam may be applied to the workpiece 11 to form holes in the workpiece 11.

Details of the laser beam applying unit 36 will be described below. FIG. 3 schematically illustrates the laser beam applying unit 36 in front elevation, partly in block form. As illustrated in FIG. 3, the laser beam applying unit 36 applies a laser beam 50 to the workpiece 11 to perform a laser processing such as an ablating process on the workpiece 11.

The laser beam applying unit 36 includes a laser oscillator 52 such as a yttrium aluminum garnet (YAG) laser, a yttrium orthovanadate (YVO₄) laser, or a yttrium lithium fluoride (YLF) laser for emitting the laser beam 50 in a pulsed oscillation mode and an output power adjusting unit 54 such as an attenuator for adjusting the output power of the laser beam 50 emitted from the laser oscillator 52. The laser beam applying unit 36 also includes an optical system 56 for guiding the laser beam 50 to the workpiece 11 held on the holding table 28. The optical system 56 includes a plurality of optical elements that control the direction of travel, shape, and focused spot position, for example, of the laser beam 50.

Specifically, the optical system 56 includes a position adjusting unit 58 for adjusting the position to be irradiated with the laser beam 50, i.e., the direction of travel of the laser beam 50. The position adjusting unit 58 changes the direction of travel of the laser beam 50 that has been emitted from the laser oscillator 52 and has had its output power adjusted by the output power adjusting unit 54, thereby adjusting the position on a polygon mirror 64, to be described below, to be irradiated with the laser beam 50. For example, the position adjusting unit 58 includes an acousto-optic deflector (AOD), an electro-optic deflector (EOD), a galvanoscanner, or an optical MEMS, for example. However, the position adjusting unit 58 may be of any of other configurations as long as they can adjust the direction of travel of the laser beam 50.

The optical system 56 includes a pair of mirrors 60 and 62 and the polygon mirror 64 for reflecting the laser beam 50. For example, dielectric multilayer mirrors are used as the mirrors 60 and 62. The laser beam 50 emitted from the position adjusting unit 58 is reflected by the reflecting surfaces of the mirrors 60 and 62 and then applied to the polygon mirror 64. The polygon mirror 64 is shaped as a polygonal prism and has a multifaceted side surface, i.e., a multifaceted outer peripheral surface, made up of a plurality of flat reflective facets, i.e., mirror facets, 66. Each of the reflective facets 66 is positioned between and joined to two adjacent reflective facets 66, and the joint between each pair of two adjacent reflective facets 66 provides an apex on the multifaceted side surface of the polygon mirror 64.

The polygon mirror 64 is coupled to a rotary actuator such as an electric motor for rotating the polygon mirror 64 about its central axis 64a. The rotary actuator includes a columnar rod or shaft 68 as an output shaft thereof. The rod 68 extends along the height or thickness of the polygon mirror 64, i.e., along the central axis thereof, and has a distal end fixed to the center of the polygon mirror 64. The polygon mirror 64 and the rotary actuator are installed in position such that the central axis 64a extends along the Y-axis. When the rotary actuator is energized, it rotates the rod 68 and hence the polygon mirror 64 about the central axis 64a.

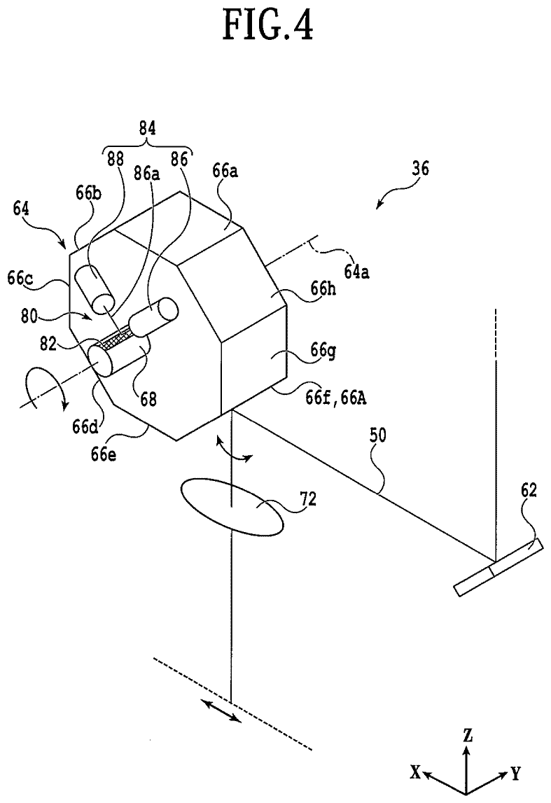

As illustrated in FIG. 4, specifically, the polygon mirror 64 is shaped as an octagonal prism having eight reflective facets 66 that are also denoted by 66a through 66h in FIGS. 4, 5, 8, and 9. Either one of the reflective facets 66a through 66h, the reflective facet 66f in FIG. 4, is referred to as an irradiated facet 66A that is irradiated with the laser beam 50. When the polygon mirror 64 rotates about the central axis 64a, each of the reflective facets 66a through 66h becomes the irradiated facet 66A in turn. The shape of the polygon mirror 64 and the number of the reflective facets 66 may be varied depending on the specifications of the laser processing apparatus 2 and the details of the way in which the workpiece 11 is processed by the laser beam 50.

When the laser beam 50 is applied to the polygon mirror 64 while the polygon mirror 64 is rotating about the central axis 64a, the laser beam 50 is reflected by the irradiated facet 66A. The rotation of the polygon mirror 64 continuously changes the angle of the irradiated facet 66A with respect to the laser beam 50 applied to the irradiated facet 66A, i.e., the direction of travel of the laser beam 50 falling on the irradiated facet 66A. Therefore, the direction of travel of the laser beam 50 reflected from the irradiated facet 66A continuously varies, enabling the laser beam 50 to scan or disperse a predetermined scanned or dispersed region. When the polygon mirror 64 rotates at a high speed in a number of cycles, the reflective facets 66a through 66h successively switch to the irradiated facet 66A in turn. Consequently, the laser beam 50 scans the scanned region in a number of cycles at a high speed.

As illustrated in FIG. 3, the optical system 56 includes a beam condenser 70 for focusing the laser beam 50. The beam condenser 70 includes a condensing lens 72 such as an fθ lens, for example, for focusing the laser beam 50 deflected by the polygon mirror 64 and applying the focused laser beam 50 to the workpiece 11. The laser beam 50 reflected by the irradiated facet 66A of the polygon mirror 64 is applied to the beam condenser 70 and focused by the condensing lens 72 onto a predetermined position, e.g., the face side 11a, the reverse side 11b, or the inside of the workpiece 11.

When the position adjusting unit 58 changes the direction of travel of the laser beam 50 to the mirror 60, the position where the laser beam 50 is applied to the irradiated facet 66A of the polygon mirror 64 is adjusted. The laser beam 50 can thus be applied to the irradiated facet 66A at a desired position thereon. When the position adjusting unit 58 shifts the direction of travel of the laser beam 50 off the mirror 60, the laser beam 50 stops being applied to the irradiated facet 66A. In other words, the position adjusting unit 58 is able to control the laser beam 50 to switch between being applied to the irradiated facet 66A and being not applied to the irradiated facet 66A, i.e., to fall on or off the irradiated facet 66A.

The optical system 56 should preferably include a beam damper 74 for interrupting the laser beam 50 emitted from the position adjusting unit 58. For stopping applying the laser beam 50 to the irradiated facet 66A, the position adjusting unit 58 adjusts the direction of travel of the laser beam 50 in order to cause the laser beam 50 to fall on the beam damper 74 rather than on the mirror 60. In this manner, the laser beam 50 stops being applied to the irradiated facet 66A with safety.

The optical system 56 for guiding the laser beam 50 to the workpiece 11 is made up of the optical elements described above. According to the present invention, however, the optical system 56 is not limited to any particular optical elements. The optical system 56 may include other optical elements including mirrors and lenses, a polarizing beam splitter (PBS), a diffractive optical element (DOE), and a liquid crystal on silicon-spatial light modulator (LCOS-SLM), for example.

The laser processing apparatus 2 further includes an irradiated facet specifying unit 80 for specifying one at a time of the reflective facets 66a through 66h as the irradiated facet 66A irradiated with the laser beam 50 among the reflective facets 66 of the polygon mirror 64. The irradiated facet specifying unit 80 has, for example, the controller 48, a detectable mark 82 positioned for rotation together with the polygon mirror 64, and a sensor 84 positioned independently of the polygon mirror 64 for detecting the detectable mark 82. The sensor 84 may detect the detectable mark 82 either directly and actively or indirectly and passively by directly and actively detecting another area than the detectable mark 82. The irradiated facet specifying unit 80 is able to monitor in real time which of the reflective facets 66 of the polygon mirror 64 is being irradiated with the laser beam 50.

FIG. 4 illustrates in perspective an example of the polygon mirror 64 and the irradiated facet specifying unit 80. The detectable mark 82 represents a portion of the side surface of the rod 68 coupled to the polygon mirror 64. The sensor 84 includes a light emitting unit, i.e., a light emitter or a light projector, 86 for emitting light, i.e., detecting light, 86a and a light detecting unit, i.e., a light detector, 88 for detecting the light 86a. The light emitting unit 86 and the light detecting unit 88 are supported by a support, not depicted, independent of the polygon mirror 64 and hence do not rotate together with the polygon mirror 64.

The light emitting unit 86 includes a light source such as an LED, for example, and emits the light 86a from the light source outwardly. However, the light emitting unit 86 may be optically connected to a light source via an optical fiber and may emit the light 86a from the light source outwardly. The light detecting unit 88 includes a photoelectric transducer for converting the light 86a that has arrived at the light detecting unit 88 into an electric signal, i.e., a voltage. The light detecting unit 88 generates a signal, i.e., an amount-of-light signal, commensurate with the amount of the light 86a detected by the light detecting unit 88 and transmits the generated amount-of-light signal to the controller 48.

The sensor 84 operates as follows. The light 86a emitted from the light emitting unit 86 is applied to the rod 68 and reflected by the side surface of the rod 68. When the light 86a reflected by the side surface of the rod 68 reaches the light detecting unit 88, the light detecting unit 88 detects the intensity, i.e., the amount, of the light 86a falling on the light detecting unit 88. The detectable mark 82 is arranged such that an area of the side surface of the rod 68 where the detectable mark 82 is located, or stated otherwise, the detectable mark 82 itself, and another area of the side surface of the rod 68 where the detectable mark 82 is not located have different reflective with respect to the light 86a. For example, the detectable mark 82 is arranged in such a manner as to have a lower reflectance than the area of the rod 68 where the detectable mark 82 is not located.

When the sensor 84 is activated while the polygon mirror 64 and the rod 68 are rotating about the central axis 64a, the light emitting unit 86 applies the light 86a to the side surface of the rod 68 upon rotation of the detectable mark 82 in unison with the polygon mirror 64 and the rod 68. The light 86a is reflected by the side surface of the rod 68 and detected by the light detecting unit 88. The intensity of the light 86a detected by the light detecting unit 88 varies depending on whether the detectable mark 82 is irradiated with the light 86a or not. Specifically, while the detectable mark 82 is being irradiated with the light 86a, the light 86a is less reflected by the side surface of the rod 68 than while the area of the side surface of the rod 68 where the detectable mark 82 is not located is being irradiated with the light 86a. As a result, the amount of the light 86a that reaches the light detecting unit 88 is reduced and so is the amount of the light 86a detected by the light detecting unit 88.

With the detectable mark 82 and the sensor 84 being arranged as described above, it is possible to specify the position of the detectable mark 82, i.e., the angle of the detectable mark 82 around the central axis 64a, on the basis of a change in the amount of the light 86a detected by the light detecting unit 88. For example, it is possible to determine whether the detectable mark 82 is positioned at a predetermined position, i.e., at an upper end of the rod 68 as illustrated in FIG. 4, by comparing the amount of the light 86a detected by the light detecting unit 88 with a predetermined reference value.

The detectable mark 82 may be of any of various specific configurations as long as they are capable of making the detectable mark 82 and the other area of the side surface of the rod 68 where the detectable mark 82 is not located have different reflective properties. The detectable mark 82 may detachably attached to the rod 68 or may be permanently formed on the rod 68 itself. For example, the detectable mark 82 may include a black seal that absorbs the light 86a and be affixed to the area of the side surface of the rod 68. The black seal as the detectable mark 82 causes a reduction in the amount of the light 86a detected by the light detecting unit 88 only while the detectable mark 82 is being irradiated with the light 86a. Alternatively, the detectable mark 82 may include a stretch of fine surface irregularities formed in the area of the side surface of the rod 68 or a member having fine surface irregularities that is secured to the area of the side surface of the rod 68. When the light 86a is applied to the fine surface irregularities as the detectable mark 82, the light 86a is scattered thereby and becomes less likely to reach the light detecting unit 88, resulting in a reduction in the amount of the light 86a detected by the light detecting unit 88.

In order to make a clear distinction between when the light 86a is applied to the detectable mark 82 and when the light 86a is applied to the area where the detectable mark 82 is not located, it is preferable to keep at a certain level or higher the difference between a reflectance R₁ of the detectable mark 82 with respect to the light 86a and a reflectance R₂ of the area where the detectable mark 82 is not located with respect to the light 86a. For example, the reflectance R₁ of the detectable mark 82 is set to 50% or less, or preferably 30% or less, of the reflectance R₂.

The position of the detectable mark 82 is established so as to have the irradiated facet 66A of the polygon mirror 64 and the detectable mark 82 placed in a predetermined positional relation. For example, the detectable mark 82 is disposed on a portion of the side surface of the rod 68 that faces the reflective facet 66a of the polygon mirror 64. The sensor 84 is positioned such that the light 86a emitted from the light emitting unit 86 is applied to the upper end of the rod 68. With the detectable mark 82 and the sensor 84 being thus positioned, at the time when the reflective facet 66a comes to the uppermost end of the polygon mirror 64 and the reflective facet 66f becomes the irradiated facet 66A, the detectable mark 82 is positioned at the upper end of the rod 68 and detected by the sensor 84. It is therefore possible to specify the irradiated facet 66A upon detection of the detectable mark 82 by the sensor 84.

However, the position of the detectable mark 82 is not limited to the illustrated position. The detectable mark 82 may be detected by the sensor 84 at the time when either one of the reflective facets 66a through 66e, 66g, and 66h becomes the irradiated facet 66A. Moreover, the detectable mark 82 may be positioned so as to face either one of the reflective facets 66b through 66h or may be placed in a position on the surface of a distal end of the rod 68 that is spaced from the central axis 64a of the rod 68.

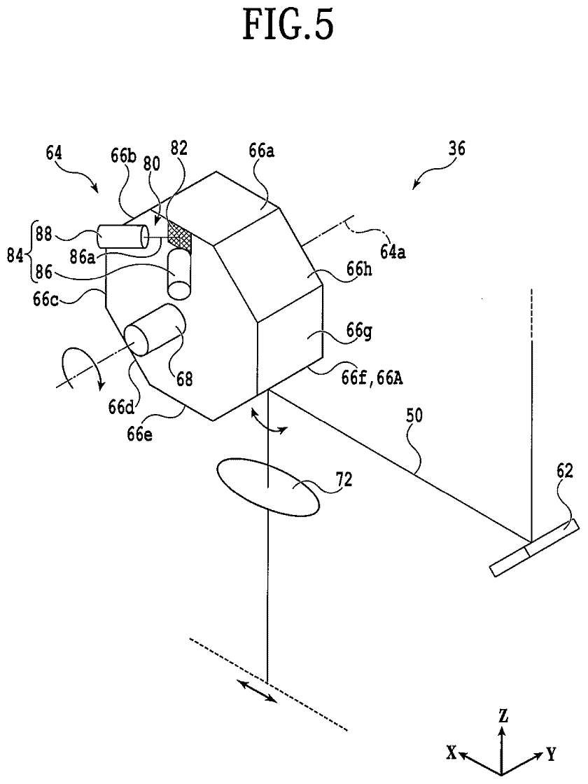

FIG. 5 illustrates in perspective another example of the polygon mirror 64 and the irradiated facet specifying unit 80. According to the example illustrated in FIG. 5, the detectable mark 82 is disposed on an axial end face of the polygon mirror 64. The detectable mark 82 is arranged such that the detectable mark 82 and an area of the axial end face of the polygon mirror 64 where the detectable mark 82 is not located have different reflective properties, e.g., reflectances, with respect to the light 86a that is applied to the axial end face of the polygon mirror 64. For example, the detectable mark 82 is disposed on a portion of the axial end face of the polygon mirror 64 that is adjacent to the reflective facet 66a of the polygon mirror 64. The sensor 84 is positioned such that the light 86a emitted from the light emitting unit 86 is applied to an upper end portion of the axial end face of the polygon mirror 64. With the detectable mark 82 and the sensor 84 being positioned as illustrated in FIG. 5, at the time when the reflective facet 66a comes to the uppermost end of the polygon mirror 64 and the reflective facet 66f becomes the irradiated facet 66A, the detectable mark 82 is detected by the sensor 84.

As described above, the detectable mark 82 that rotates together with the polygon mirror 64 is detected by the sensor 84. The sensor 84, i.e., the light detecting unit 88, generates a signal, i.e., an amount-of-light signal, commensurate with the amount of the light 86a detected by the light detecting unit 88 and transmits the generated amount-of-light signal to the controller 48 (see FIG. 3).

The detectable mark 82 is illustrated as being disposed on the side surface of the rod 68 (see FIG. 4) or on the axial end face of the polygon mirror 64 (see FIG. 5). However, the detectable mark 82 may be disposed anywhere else as long as it rotates together with the polygon mirror 64. For example, the detectable mark 82 may be disposed on at least one of the reflective facets 66 of the polygon mirror 64 or on another member than the rod 68 that is coupled to the polygon mirror 64. Further alternatively, the detectable mark 82 may be combined with a rotor that is disposed independently of the polygon mirror 64 and rotatable at the same angular velocity as that of the polygon mirror 64. Nevertheless, it is preferable to place the detectable mark 82 in positions other than the reflective facets 66 of the polygon mirror 64. Specifically, providing the detectable mark 82 is located in those positions, since the reflective facets 66 of the polygon mirror 64 are not required to take into account their reflectances with respect to the light 86a, the reflective facets 66 can optically be configured only in view of the reflective properties of the reflective facets 66 with respect to the laser beam 50. The polygon mirror 64 can thus be designed and installed with ease.

As described above, the laser processing apparatus 2 includes the measuring unit 42 (see FIG. 3) that measures the position of a region, i.e., an irradiated region, irradiated with the laser beam 50 scanned or deflected by the polygon mirror 64. The measuring unit 42 is disposed on the X-axis movable table 22 adjacent to the holding table 28, for example. For example, the measuring unit 42 includes a beam profiler for measuring a spatial intensity distribution of the laser beam 50. The intensity distribution of the laser beam 50 scanned by the polygon mirror 64 is measured by the measuring unit 42.

FIG. 6 illustrates in front elevation the laser beam applying unit 36 and the measuring unit 42. The measuring unit 42 includes a columnar support structure 100 coupled to the moving assembly 6 and a moving unit or mechanism 102 disposed on a front surface of the support structure 100. A measuring instrument 104 for measuring an intensity distribution of the laser beam 50 is coupled to the moving unit 102.

The moving unit 102 includes, for example, a ball-screw-type moving mechanism as with the Y-axis moving unit 8 and the X-axis moving unit 18 (see FIG. 1). The moving unit 102 moves the measuring instrument 104 along the Z-axis, i.e., selectively lifts and lowers the measuring instrument 104, to adjust the positional relation between the polygon mirror 64 and the measuring instrument 104.

The measuring instrument 104 includes a casing 106 that houses its components therein. A microscope 108 for magnifying the laser beam 50 is mounted on an upper end of the casing 106. The microscope 108 has a magnifying power ranging from 5 to 100 times depending on the diameter and shape of the laser beam 50. The casing 106 houses therein an attenuating optical system 110 for attenuating the laser beam 50 and an image capturing unit 112 for detecting and capturing an image of the laser beam 50.

The attenuating optical system 110 guides the laser beam 50 to the image capturing unit 112 while attenuating the intensity of the laser beam 50 that has been magnified by the microscope 108. For example, the attenuating optical system 110 includes a natural density (ND) filter for reducing the amount of light of the laser beam 50. However, the attenuating optical system 110 is not limited to any particular types and configurations and may include an attenuator including a plurality of prisms, for example.

The image capturing unit 112 detects and captures an image of the laser beam 50 that has been magnified by the microscope 108 and attenuated by the attenuating optical system 110. Specifically, the image capturing unit 112 includes a light sensor such as a CMOS sensor, for example, and has a light detecting surface 112a for detecting the laser beam 50. The image capturing unit 112 measures, with the light sensor, an intensity distribution of the laser beam 50 detected by the light detecting surface 112a.

The measuring unit 42 operates as follows. While the measuring unit 42 is being placed immediately below the polygon mirror 64, the laser beam 50 is applied to the polygon mirror 64 that is rotating about the central axis 64a. The laser beam 50 is scanned by the polygon mirror 64 and applied to the measuring unit 42. In the measuring unit 42, the laser beam 50 is applied to and magnified by the microscope 108 and is then attenuated by the attenuating optical system 110. The attenuated laser beam 50 then reaches the image capturing unit 112 and is detected by the image capturing unit 112. When the image capturing unit 112 detects the laser beam 50, the intensity of the laser beam 50 is measured in a region of the light detecting surface 112a that is irradiated with the laser beam 50, i.e., an irradiated region. In this manner, the position of the irradiated region irradiated with the laser beam 50 is specified. For example, the irradiated region refers to a region of the light detecting surface 112a where the intensity of the laser beam 50 is detected or a region where the intensity of the laser beam 50 is equal to or higher than a predetermined threshold value.

The position of the irradiated region irradiated with the laser beam 50 can be extracted from the intensity distribution of the laser beam 50 measured by the measuring unit 42, i.e., the beam profiler. The measuring unit 42 may be of any of various types as long as they are able to specify the irradiated region irradiated with the laser beam 50. For example, the measuring unit 42 may include a wavefront sensor capable of detecting the wavefront of the laser beam 50 and generating a phase distribution of the wavefront of the laser beam 50. In a case where the measuring unit 42 includes a wavefront sensor, the irradiated region irradiated with the laser beam 50 is reflected in the phase distribution of the wavefront, and the position of the irradiated region irradiated with the laser beam 50 can be extracted from the phase distribution of the wavefront of the laser beam 50.

The measuring unit 42 incorporated in the laser processing apparatus 2 can specify the position of the irradiated region irradiated with the laser beam 50 scanned by the polygon mirror 64. For example, the measuring unit 42 thus makes it unnecessary to perform a complex process of processing a test sample with the laser beam 50 in a trial experiment and specifying the position of the irradiated region irradiated with the laser beam 50 from the position of a processed mark on the test sample. As a consequence, the task of confirming the position of the irradiated region irradiated with the laser beam 50 is simplified.

In FIG. 6, the measuring unit 42 is illustrated as measuring the laser beam 50 that has passed through the beam condenser 70. According to the present invention, the position of the irradiated region irradiated with the laser beam 50 that has been scanned by the polygon mirror 64 may be specified by any of various other devices. For example, the laser processing apparatus 2 may include, instead of the measuring unit 42, an alternative measuring unit for measuring the position of the irradiated region irradiated with the laser beam 50 between the polygon mirror 64 and the beam condenser 70. The alternative measuring unit is movable between a measuring position on the path of the laser beam 50 between the polygon mirror 64 and the beam condenser 70 and a retracted position off the path of the laser beam 50. For measuring the intensity distribution of the laser beam 50, the alternative measuring unit is placed in the measuring position and measures the position of the irradiated region irradiated with the laser beam 50 between the polygon mirror 64 and the beam condenser 70. The measuring unit may thus be installed in a desired position downstream of the polygon mirror 64 with respect to the direction in which the laser beam 50 travels.

The controller 48 illustrated in FIG. 3 is electrically connected to the components of the laser beam applying unit 36, i.e., the measuring unit 42, the laser oscillator 52, the output power adjusting unit 54, the position adjusting unit 58, the rotary actuator for rotating the polygon mirror 64, and the sensor 84 that includes the light emitting unit 86 and the light detecting unit 88. The controller 48 outputs control signals to these components of the laser beam applying unit 36 to control operations of the components for thereby processing the workpiece 11 with the laser beam 50.

When the laser beam 50 is applied to the workpiece 11 to process the workpiece 11 with the laser beam 50, the irradiated region irradiated with the laser beam 50 produces a melted substance called debris. The produced debris is solidified again, i.e., backfills or is recast in the irradiated region, tending to obstruct an efficient application of the laser beam. However, when the laser beam 50 is applied to the polygon mirror 64 that is rotating about the central axis 64a at a high speed, the laser beam 50 is reflected by the polygon mirror 64 to scan the workpiece 11 repeatedly in a number of cycles at a high speed, processing the workpiece 11 with the laser beam 50 while preventing the debris from being solidified again.

Ideally, the polygon mirror 64 should be shaped as a regular polygonal prism such that all the reflective facets 66 lie parallel to the central axis 64a. Actually, however, it is difficult to keep all the reflective facets 66 parallel to the central axis 64a due to polygon mirror fabrication process errors, and the angles of the reflective facets 66 with respect to the central axis 64a are slightly different from each other. If the reflective facets 66 that are slightly inclined to the central axis 64a and hence out of parallel to the central axis 64a become the irradiated facet 66A in turn, the focused spot of the laser beam 50 varies in position, and the laser beam 50 may be applied to irradiate unintended regions of the workpiece 11.

According to the present embodiment, a position where the laser beam 50 is applied to the irradiated facet 66A is adjusted with respect to each of the reflective facets 66. Hence, the focused spot of the laser beam 50 is prevented from varying in position regardless of the different angles of the reflective facets 66 with respect to the central axis 64a. The laser beam 50 reflected by the inclined reflective facets 66 is thus prevented from being applied to unintended regions of the workpiece 11.

A specific example of a laser beam applying method that applies the laser beam 50 to the reflective facets 66 of the polygon mirror 64, i.e., a method of processing a workpiece, will be described in detail below. According to the present embodiment, the polygon mirror 64 scans the laser beam 50 while the position where the laser beam 50 is applied to the irradiated facet 66A is being adjusted with respect to each of the reflective facets 66.

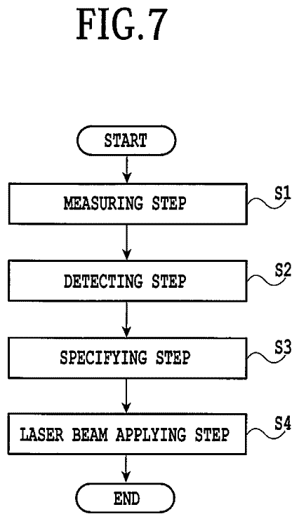

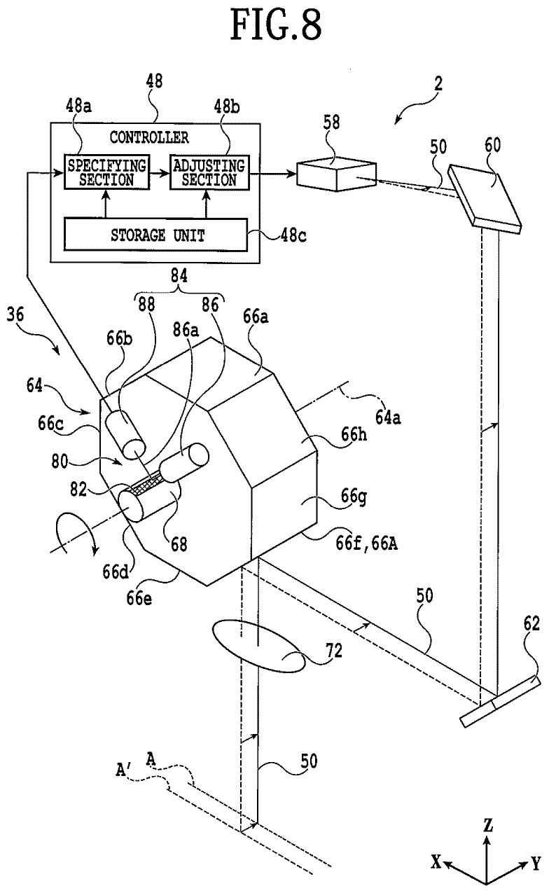

FIG. 7 is a flowchart of the laser beam applying method. FIG. 8 illustrates in perspective, partly in block form, of the laser processing apparatus 2 while it is carrying out the laser beam applying method. As illustrated in FIG. 7, the laser beam applying method according to the present embodiment includes a measuring step S1, a detecting step S2, a specifying step S3, and a laser beam applying step S4 that are carried out in succession in the order named. Of the above steps, the detecting step S2 and the specifying step S3 jointly make up a process referred to as an irradiated facet specifying method that specifies the irradiated facet 66A irradiated with the laser beam 50. The laser beam applying method and the irradiated facet specifying method according to the present embodiment will be described in detail below primarily with reference to FIGS. 7 and 8.

According to the laser beam applying method and the irradiated facet specifying method, the components of the laser processing apparatus 2 are controlled in operation by the controller 48. As illustrated in FIG. 8, the controller 48 includes a specifying section 48a for specifying the irradiated facet 66A of the polygon mirror 64 and an adjusting section 48b for controlling the position adjusting unit 58 to adjust the position to be irradiated with the laser beam 50. The controller 48 also includes a storage unit (memories) 48c for storing various pieces of information such as data and programs that are used in processing operations carried out by the specifying section 48a and the adjusting section 48b. The specifying section 48a and the adjusting section 48b correspond to the processing unit referred to above, whereas the storage unit 48c corresponds to the storage unit referred to above.

The storage unit 48c stores in advance information, i.e., irradiated facet information, representing the relation between the action to detect the detectable mark 82 by the sensor 84 and the irradiated facet 66A of the polygon mirror 64. Specifically, the irradiated facet information indicates one of the reflective facets 66 that is positioned as the irradiated facet 66A when the detectable mark 82 is detected by the sensor 84. For example, in a case where the polygon mirror 64 and the irradiated facet specifying unit 80 are configured as illustrated in FIG. 8, the irradiated facet information indicates that the reflective facet 66f is positioned as the irradiated facet 66A when the detectable mark 82 is detected by the sensor 84. The irradiated facet information may be set and input to the controller 48 by the operator or may be generated by the controller 48.

In the laser beam applying method according to the present embodiment, first, the position of an irradiated region irradiated with the laser beam 50 that is scanned by the polygon mirror 64 is measured with respect to each of the reflective facets 66 (the measuring step S1). In the measuring step S1, specifically, the measuring unit 42 illustrated in FIG. 6 measures the position of an irradiated region irradiated with the laser beam 50 with respect to each of the reflective facets 66. Then, information, i.e., corrective information, representing a corrective quantity for the position where the laser beam 50 is applied to the irradiated facet 66A with respect to each of the reflective facets 66 is stored in the storage unit 48c.

More specifically, as illustrated in FIG. 6, the moving assembly 6 moves the measuring unit 42 along the X-axis and the Y-axis to position the measuring unit 42 directly below the polygon mirror 64. Then, the laser beam 50 is applied to the polygon mirror 64 that is rotating about its central axis 64a, and is scanned or deflected by the polygon mirror 64. As a result, the laser beam 50 scanned by the polygon mirror 64 is applied to the measuring unit 42.

The measuring unit 42 measures the position of the irradiated region irradiated with the laser beam 50 that is scanned by the polygon mirror 64. Specifically, as described above, the measuring unit 42 measures an intensity distribution of the laser beam 50 and extracts the position, i.e., the scanned position, of the irradiated region irradiated with the laser beam 50 from the measured intensity distribution of the laser beam 50. The measuring unit 42 measures the position of the irradiated region irradiated with the laser beam 50 at the time when the laser beam 50 is applied to each of the reflective facets 66a through 66h. Therefore, the positions of the irradiated regions irradiated with the laser beam 50 are measured with respect to the respective reflective facets 66a through 66h.

The positions of the irradiated regions irradiated with the laser beam 50 that have been measured by the measuring unit 42 are output to the controller 48 (see FIG. 8). Then, the controller 48 calculates corrective quantities for the positions irradiated with the laser beam 50, required to scan the laser beam 50 at desired positions, with respect to the respective reflective facets 66a through 66h. Each of the corrective quantities is representative of the difference between a position to be irradiated with the laser beam 50 and the position of the irradiated region irradiated with the laser beam 50 that has been measured by the measuring unit 42.

For example, it is assumed that the reflective facets 66a through 66e, 66g, and 66h lie parallel to the central axis 64a of the polygon mirror 64 and the reflective facet 66f is slightly inclined to the central axis 64a due to fabrication process errors. While the laser beam 50 is being applied to the reflective facets 66a through 66e, 66g, and 66h, the laser beam 50 is normally scanned along a straight path A that is to be irradiated with the laser beam 50. However, when the laser beam 50 is applied to the reflective facet 66f, the laser beam 50 is reflected by the reflective facet 66f to travel in a different direction due to the inclination thereof and scanned along a path A′ spaced from the straight path A to be irradiated with the laser beam 50.

The controller 48 now calculates the difference or error between the position of the path A and the position of the path A′ on the Y-axis. For example, the coordinates of the path A are stored in advance in the storage unit 48c, and the controller 48 calculates the difference between the stored coordinates of the path A and the coordinates of the irradiated region irradiated with the laser beam 50 measured by the measuring unit 42, i.e., the coordinates of the path A′. Then, the controller 48 determines corrective quantities for the irradiated positions where the irradiated facet 66A is irradiated with the laser beam 50 with respect to the respective reflective facets 66a through 66h so as to bring the position on the workpiece 11 irradiated with the laser beam 50 into alignment with the position on the workpiece 11 to be processed by the laser beam 50.

Specifically, when the laser beam 50 is applied to the reflective facets 66a through 66e, 66g, and 66h, the position to be irradiated with the laser beam 50 and the position actually irradiated with the laser beam 50 are aligned with each other. Therefore, the position on the workpiece 11 that is irradiated with the laser beam 50 does not need to be corrected (corrective quantity=0). On the other hand, when the laser beam 50 is applied to the reflective facet 66f, the position where the reflective facet 66f is irradiated with the laser beam 50 needs to be adjusted in order to bring the position, i.e., the path A′, where the laser beam 50 is actually applied into alignment with the position, i.e., the path A, where the laser beam 50 is to be applied. The amount by which the position where the reflective facet 66f is irradiated with the laser beam 50 is to be varied corresponds to the corrective quantity.

In the measuring step S1, as described above, the position of the irradiated region irradiated with the laser beam 50 that is scanned by the polygon mirror 64 is measured with respect to each of the reflective facets 66. The controller 48 then stores, as the corrective information, the corrective quantity for each of the reflective facets 66 into the storage unit 48c.

The position of the irradiated region irradiated with the laser beam 50 may be measured by other processes than the above process using the measuring unit 42. For example, in the measuring step S1, a test sample may be processed with the laser beam 50 in a trial experiment using the polygon mirror 64, and the position of the irradiated region irradiated with the laser beam 50 may be specified from the result of the trial experiment. According to this alternative process, the measuring unit 42 may be omitted from the laser processing apparatus 2. Specifically, first, the test sample is held on the holding table 28 (see FIGS. 1 and 3). Then, the laser beam 50 as it is scanned by the polygon mirror 64 is applied to the test sample. The test sample is now processed by the laser beam 50, with a processed linear mark left on the test sample. The position where the processed linear mark is formed on the test sample represents the position of the irradiated region irradiated with the laser beam 50. Thereafter, the image capturing unit 40 (see FIG. 1) captures an image of the test sample including the processed liner mark. The controller 48 then specifies the position of the processed linear mark, i.e., the position of the irradiated region irradiated with the laser beam 50, on the basis of the captured image of the processed linear mark.

Further alternatively, inclinations of the reflective facets 66 of the polygon mirror 64 may be measured, and positions of the irradiated regions irradiated with the laser beam 50 may be specified on the basis of the measured inclinations of the reflective facets 66. For example, an inclination measuring instrument, not depicted, for measuring inclinations of the reflective facets 66 of the polygon mirror 64 may be installed in the vicinity of the polygon mirror 64. The inclination measuring instrument may include an autocollimator, for example. The inclination measuring instrument measures inclinations of the reflective facets 66a through 66h with respect to the central axis 64a of the polygon mirror 64 and outputs the measured inclinations to the controller 48. The controller 48 calculates positions of the irradiated regions irradiated with the laser beam 50 with respect to the respective reflective facets 66a through 66h on the basis of the inclinations of the reflective facets 66a through 66h measured by the inclination measuring instrument.

According to a yet further alternative, the inclinations of the reflective facets 66 may be measured and recorded before the polygon mirror 64 is installed in the laser processing apparatus 2. Positions of the irradiated regions irradiated with the laser beam 50 and corrective quantities therefor may be calculated on the basis of the recorded inclinations of the reflective facets 66 and stored in the storage unit 48c of the controller 48. After positions of the irradiated regions irradiated with the laser beam 50 and corrective quantities therefor have been calculated outside of the laser processing apparatus 2, the operator may input them to the controller 48, or the controller 48 may calculate positions of the irradiated regions irradiated with the laser beam 50 and corrective quantities therefor on the basis of the inclinations of the reflective facets 66.

Then, the laser processing apparatus 2 carries out a laser processing operation on the workpiece 11. First, the controller 48 inputs a control signal to the rotary actuator, not depicted, coupled to the polygon mirror 64, thereby rotating the rod 68 and hence the polygon mirror 64 about the central axis 64a. There is no limitation on the speed at which the polygon mirror 64 rotates. The speed at which the polygon mirror 64 rotates may be set to 500 revolutions per second, for example. The laser beam 50 emitted from the position adjusting unit 58 is reflected by the mirrors 60 and 62 and applied to the polygon mirror 64, and is then scanned or deflected by the polygon mirror 64.

At this time, the irradiated facet 66A to which the laser beam 50 is applied among the reflective facets 66 of the polygon mirror 64 is specified by the irradiated facet specifying method according to the present embodiment. Specifically, the detecting step S2 that detects the detectable mark 82 by the sensor 84 and the specifying step S3 that specifies the irradiated facet 66A on the basis of the detection of the detectable mark 82 by the sensor 84 are carried out.

In the detecting step S2, the sensor 84 is energized to detect the detectable mark 82. Specifically, the light 86a emitted from the light emitting unit 86 is applied to the rod 68 that rotates together with the polygon mirror 64. The light 86a that is reflected by the rod 68 reaches the light detecting unit 88 and is detected by the light detecting unit 88. The light detecting unit 88 generates an electric signal representing the amount of the detected light 86a and outputs the generated electric signal to the specifying section 48a of the controller 48.

As described above, the detectable mark 82 on the side surface of the rod 68 and the other area of the side surface of the rod 68 have different reflective properties with respect to the light 86a. Therefore, the detected amount of the light 86a reflected by the detectable mark 82 and the detected amount of the light 86a reflected by the other area of the side surface of the rod 68 are different from each other. The specifying section 48a determines whether the detectable mark 82 is detected by the sensor 84 or not on the basis of the signal from the light detecting unit 88, i.e., the detected amount of the light 86a. For example, the specifying section 48a determines whether the detectable mark 82 is detected by the sensor 84 or not by comparing the detected amount of the light 86a from the light detecting unit 88 with a predetermined reference value, i.e., a threshold value, stored in the storage unit 48c.

In the specifying step S3, the irradiated facet 66A to which the laser beam 50 is applied is specified among the reflective facets 66 of the polygon mirror 64 on the basis of the detection of the detectable mark 82 by the sensor 84. Specifically, if the specifying section 48a decides that the detectable mark 82 is detected by the sensor 84, then the specifying section 48a refers to the irradiated facet information stored in the storage unit 48c and specifies the irradiated facet 66A to which the laser beam 50 is applied among the reflective facets 66. Then, the specifying section 48a outputs a signal, i.e., an irradiated facet signal, representing the irradiated facet 66A to the adjusting section 48b. For example, when the sensor 84 illustrated in FIG. 8 detects the detectable mark 82, the specifying section 48a refers to the irradiated facet information, and specifies the reflective facet 66f as the irradiated facet 66A, and outputs an irradiated facet signal indicating that the reflective facet 66f acts as the irradiated facet 66A to the adjusting section 48b.

However, the irradiated facet 66A of the polygon mirror 64 may be specified in any of various other ways. For example, the irradiated facet specifying method described above, i.e., the detecting step S2 and the specifying step S3, may be omitted, and the irradiated facet 66A may instead be specified on the basis of the angular displacement, i.e., the angle of rotation, of the rotary actuator that rotates the polygon mirror 64.

Specifically, the rotary actuator incorporates therein or is connected to an encoder, not depicted, for detecting the angular displacement of the rod 68 as its own output shaft, i.e., the angular displacement of the polygon mirror 64. Information, i.e., irradiated facet information, representing the positional relation between the angular displacement of the rod 68 and the irradiated facet 66A is set in advance and stored in the storage unit 48c of the controller 48.

When the rotary actuator is energized to rotate the polygon mirror 64, the angular displacement of the rod 68 is sequentially measured by the encoder and input to the controller 48. Then, the controller 48 specifies the irradiated facet 66A on the basis of the angular displacement measured by the encoder and the irradiated facet information. It is thus possible to omit the sensor 84 and yet to specify the irradiated facet 66A of the polygon mirror 64, so that the laser beam applying unit 36 can be simplified in configuration.

Then, the laser beam 50 is applied successively to the reflective facets 66 of the polygon mirror 64. At this time, the positions where the laser beam 50 is applied to the irradiated facet 66A are adjusted with respect to the respective reflective facets 66 on the basis of the position of the irradiated region irradiated with the laser beam 50 that has been measured by the measuring unit 42 with respect to each of the reflective facets 66 in the measuring step S1 (the laser beam applying step S4).

In the laser beam applying step S4, the specifying section 48a inputs irradiated facet signals successively to the adjusting section 48b. For example, the specifying section 48a outputs irradiated facet signals indicative of the reflective facets 66a through 66h as they successively become the irradiated facet 66A consecutively to the adjusting section 48b in real time on the basis of the angle through which the polygon mirror 64 has rotated or the period of time that has elapsed from the detection of the detectable mark 82 by the sensor 84. Specifically, the irradiated facet signals input from the specifying section 48a to the adjusting section 48b switch one from another each time the polygon mirror 64 turns through 45° about the central axis 64a.

The adjusting section 48b accesses the storage unit 48c and reads the corrective information acquired in the measuring step S1 from the storage unit 48c. The adjusting section 48b refers to the corrective information and outputs signals, i.e., corrective signals, indicating corrective quantities for the positions where the laser beam 50 is applied to the reflective facets 66 represented by the irradiated facet signals, successively to the position adjusting unit 58. For example, when the specifying section 48a inputs an irradiated facet signal indicating that the reflective facet 66f acts as the irradiated facet 66A to the adjusting section 48b, the adjusting section 48b refers to the corrective information and outputs a corrective quantity for the position where the laser beam 50 is applied to the reflective facet 66f to the position adjusting unit 58.

At the timing of actually applying the laser beam 50 to the reflective facets 66, the position adjusting unit 58 corrects the positions where the laser beam 50 is applied to the reflective facets 66. The position where the laser beam 50 is applied to the irradiated facet 66A is thus adjusted with respect to each of the reflective facets 66. As a result, while the laser beam 50 is being scanned by the polygon mirror 64, the position of the focused spot of the laser beam 50 is corrected to scan the laser beam 50 along the path A to be irradiated therewith. In FIG. 8, the path of the laser beam 50 before the irradiated position is corrected is indicated by the broken lines, whereas the path of the laser beam 50 after the irradiated position has been corrected is indicated by the solid lines.

The workpiece 11 is processed by the laser beam 50 whose irradiated position has been adjusted as described above. For example, when the laser beam 50 is applied to the workpiece 11 along the streets 13 (see FIG. 2) thereof as described above, the workpiece 11 is ablated and divided along the streets 13. In this case, the path A is established centrally widthwise on each of the streets 13, and the laser beam 50 is scanned by the polygon mirror 64 to have its focused spot positioned on the path A.

If the reflective facets 66 of the polygon mirror 64 suffer angle variations, then the focused spot of the laser beam 50 is positioned on the path A′ spaced from the path A. When the laser beam 50 is scanned to have its focused spot positioned on the path A′, the positions where the laser beam 50 ablates the workpiece 11 are shifted, tending to cause damage to the devices 15 and processing failures such as dimensional variations of the device chips. According to the present embodiment, however, the position where the irradiated facet 66A is irradiated with the laser beam 50 is adjusted to positionally correct the focused spot of the laser beam 50 reflected by the inclined reflective facets 66 to run along the path A, not the path A′. Therefore, even in the presence of angle variations of the reflective facets 66, the laser beam 50 is scanned while its focused spot is being kept on the path A. As a result, the workpiece 11 is processed with increased accuracy and suffers reduced processing failures.

The irradiated position that is irradiated with the laser beam 50 along the X-axis may be adjusted by changing the timing of applying the laser beam 50 to the polygon mirror 64, i.e., the timing of turning on and off the laser beam 50. Specifically, the timing of changing the destination of the laser beam 50 emitted from the position adjusting unit 58 from the mirror 60 to the beam damper 74 (see FIG. 3) and the timing of changing the destination of the laser beam 50 from the beam damper 74 to the mirror 60 are controlled to adjust the irradiated position that is irradiated with the laser beam 50 along the X-axis.

By successively carrying out the measuring step S1, the detecting step S2, the specifying step S3, and the laser beam applying step S4 as described above, the laser beam 50 is applied to the workpiece 11 to process the workpiece 11 with the laser beam 50 while the position where the polygon mirror 64 is irradiated with the laser beam 50 is being adjusted with respect to each of the reflective facets 66. The measuring step S1, the detecting step S2, the specifying step S3, and the laser beam applying step S4 are performed by executing the programs stored in the controller 48. Specifically, the storage unit 48c stores the programs for generating control signals to operate the components of the laser beam applying unit 36. The controller 48 reads and executes the programs to automatically carry out the measuring step S1, the detecting step S2, the specifying step S3, and the laser beam applying step S4.

As described above, the laser processing apparatus 2 according to the present embodiment includes the position adjusting unit 58 for adjusting the position where the laser beam 50 is applied to the irradiated facet 66A with respect to each of the reflective facets 66. It is thus possible to restrain variations of the position of the irradiated region irradiated with the laser beam 50 due to angle variations of the reflective facets 66.

According to the present embodiment, the detectable mark 82 that is detected by the sensor 84 is illustrated as being disposed in a position other than the reflective facets 66 of the polygon mirror 64 (see FIGS. 4 and 5). Providing the designing of the polygon mirror 64 remains free of trouble and it is difficult to position the detectable mark 82 anywhere other than the reflective facets 66, either one of the reflective facets 66 may be used as a detectable mark as described below.

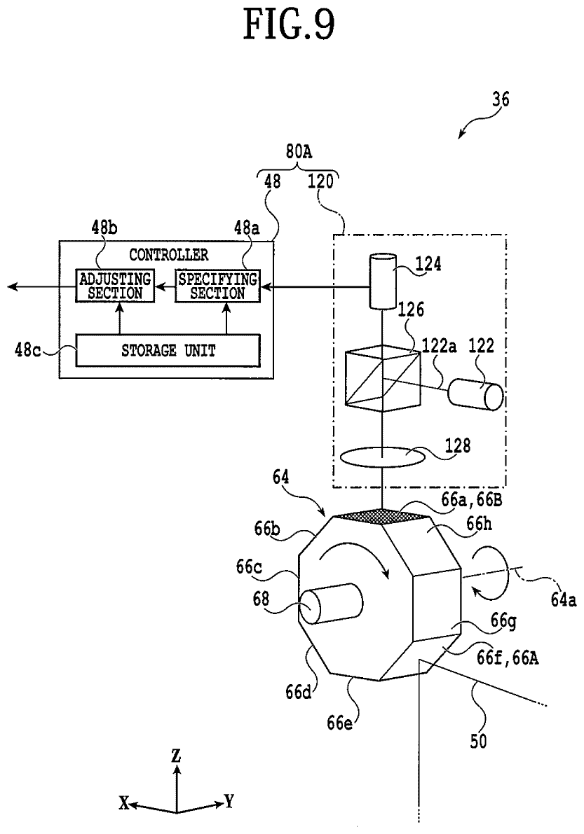

FIG. 9 illustrates in perspective, partly in block form, an irradiated facet specifying unit 80A as a modification of the irradiated facet specifying unit 80. The irradiated facet specifying unit 80A includes the controller 48 and a sensor 120 included in the laser beam applying unit 36.

At least one of the reflective facets 66 of the polygon mirror 64 is established as a detectable facet, i.e., a detectable mark, 66B that is detected by the sensor 120. The reflective facet 66a of the polygon mirror 64 will be described as the detectable facet 66B by way of example below.

The sensor 120 detects the detectable facet 66B from among the reflective facets 66 of the polygon mirror 64. The controller 48 then specifies the irradiated facet 66A irradiated with the laser beam 50, on the basis of the detection of the detectable facet 66B by the sensor 120.

Specifically, the sensor 120 includes a light emitting unit, i.e., a light emitter or a light projector, 122 for emitting light, i.e., detecting light, 122a and a light detecting unit, i.e., a light detector, 124 for detecting the light 122a. The light emitting unit 122 and the light detecting unit 124 are structurally and functionally similar respectively to the light emitting unit 86 and the light detecting unit 88 (see FIG. 8). The light 122a emitted from the light emitting unit 122 is applied to and reflected by the reflective facets 66 of the polygon mirror 64. The light 122a reflected by the reflective facets 66 is applied to the light detecting unit 124. The light detecting unit 124 then detects the intensity, i.e., the amount, of the light 122a.

The sensor 120 includes an optical system designed appropriately to make the light 122a from the light emitting unit 122 reflected by the reflective facets 66 and make the light 122a from the reflective facets 66 detected by the light detecting unit 124. For example, the sensor 120 includes a polarizing beam splitter 126 and a lens 128. The polarizing beam splitter 126 reflects the light 122a from the light emitting unit 122 toward the reflective facets 66 of the polygon mirror 64. The lens 128 further narrows down the light 122a reflected by the polarizing beam splitter 126 and makes the light 122a travel toward the reflective facets 66 of the polygon mirror 64. The lens 128 includes a collimator lens, for example. The light 122a reflected by the reflective facets 66 travels through the lens 128 and the polarizing beam splitter 126 to the light detecting unit 124. The light 122a is thus detected by the light detecting unit 124.

The detectable facet 66B of the polygon mirror 64 is arranged to make the detectable facet 66B and the other reflective facets 66 than the detectable facet 66B have different reflective properties with respect to the light 122a applied thereto. For example, the detectable facet 66B has a higher reflectance than the other reflective facets 66 than the detectable facet 66B with respect to the light 122a applied thereto. Each of the reflective facets 66 of the polygon mirror 64 includes a layered assembly of thin films including a hafnium oxide film and a silicon oxide film, for example. The detectable facet 66B as one of the reflective facets 66 and the other reflective facets 66 have different layered structures, e.g., different film thicknesses, different numbers of films, and/or different film materials, to make the detectable facet 66B and the other reflective facets 66 than the detectable facet 66B have different reflectances with respect to the light 122a applied thereto.

With the reflective facets 66 of the polygon mirror 64 being thus configured, the intensity of the light 122a detected by the light detecting unit 124 varies depending on whether the reflective facet 66 irradiated with the light 122a is the detectable facet 66B or not. Accordingly, it is possible to detect the detectable facet 66B on the basis of the amount of light detected by the light detecting unit 124. In order to clearly distinguish between the detectable facet 66B and the other reflective facets 66 on the basis of the amount of light detected by the light detecting unit 124, it is preferable that the difference between a reflectance R₁′ of the detectable facet 66B with respect to the light 122a and a reflectance R₂′ of the other reflective facets 66 with respect to the light 122a is of at least a certain level. For example, the polygon mirror 64 is configured such that one of the reflectance R₁′ and the reflectance R₂′ is at least twice the other or preferably three times the other.

The light detecting unit 124 generates a signal, i.e., an amount-of-light signal, commensurate with the amount of the light 122a detected by the light detecting unit 124 and transmits the generated amount-of-light signal to the controller 48. The storage unit 48c of the controller 48 stores information, i.e., irradiated facet information, representing the positional relation between the irradiated facet 66A and the detectable facet 66B. The irradiated facet information represents the reflective facet 66 that becomes the irradiated facet 66A when the detectable facet 66B is detected by the sensor 120. For example, in a case where the polygon mirror 64 and the irradiated facet specifying unit 80A are configured as illustrated in FIG. 9, the irradiated facet information indicates that the reflective facet 66 that is positioned three facets ahead of the detectable facet 66B with respect to the direction in which the polygon mirror 64 rotates acts as the irradiated facet 66A. More specifically, in a case where the reflective facet 66a is established as the detectable facet 66B, the irradiated facet information indicates that the reflective facet 66f acts as the irradiated facet 66A.

In order for the laser processing apparatus 2 to carry out a laser processing operation on the workpiece 11, the laser beam 50 is applied to the irradiated facet 66A of the polygon mirror 64 and scanned by the polygon mirror 64. The sensor 120 is energized to detect the detectable facet 66B of the polygon mirror 64. Specifically, the light 122a emitted from the light emitting unit 122 is applied through the polarizing beam splitter 126 and the lens 128 to one of the reflective facets 66 of the polygon mirror 64 and reflected by the reflective facets 66. At the time when the direction of travel of the light 122a applied to the reflective facet 66 becomes essentially perpendicular to the reflective facet 66, the light 122a reflected by the reflective facet 66 travels through the lens 128 and the polarizing beam splitter 126 to the light detecting unit 124 and is detected by the light detecting unit 124. The light detecting unit 124 generates an electric signal representing the amount of the light 122a that has been detected and outputs the generated electric signal to the specifying section 48a of the controller 48.

As described above, the reflective property of the polygon mirror 64 with respect to the light 122a varies and hence the amount of the light 122a detected by the light detecting unit 124 varies depending on whether the reflective facet 66 irradiated with the light 122a is the detectable facet 66B or not. The specifying section 48a determines whether the reflective facet 66 that has been irradiated with the light 122a detected by the sensor 120 is the detectable facet 66B or not on the basis of the signal from the light detecting unit 124, i.e., the amount of light detected by the light detecting unit 124. For example, the specifying section 48a determines whether the reflective facet 66 that has been irradiated with the light 122a detected by the sensor 120 is the detectable facet 66B or not by comparing the detected amount of the light 122a from the light detecting unit 124 with a predetermined reference value, i.e., a threshold value, stored in the storage unit 48c (the detecting step S2).

If the specifying section 48a decides that the reflective facet 66 that has been irradiated with the light 122a detected by the sensor 120 is the detectable facet 66B, then the specifying section 48a refers to the irradiated facet information stored in the storage unit 48c and specifies the irradiated facet 66A to which the laser beam 50 is applied among the reflective facets 66 (the specifying step S3). Then, the specifying section 48a outputs a signal, i.e., an irradiated facet signal, representing the irradiated facet 66A to the adjusting section 48b. For example, when the sensor 120 illustrated in FIG. 9 detects the reflective facet 66a, the specifying section 48a refers to the irradiated facet information, specifies the reflective facet 66f as the irradiated facet 66A, and outputs an irradiated facet signal indicating that the reflective facet 66f acts as the irradiated facet 66A to the adjusting section 48b.

The adjusting section 48b refers to the corrective information stored in the storage unit 48c and outputs signals, i.e., corrective signals, indicating corrective quantities for the positions where the laser beam 50 is applied to the reflective facets 66 represented by the irradiated facet signals, successively to the position adjusting unit 58 (see FIG. 8). For example, when the specifying section 48a inputs an irradiated facet signal indicating that the reflective facet 66f acts as the irradiated facet 66A to the adjusting section 48b, the adjusting section 48b refers to the corrective information and outputs a corrective quantity for the position where the laser beam 50 is applied to the reflective facet 66f to the position adjusting unit 58. At the timing of actually applying the laser beam 50 to the reflective facets 66, the position adjusting unit 58 corrects the positions where the laser beam 50 is applied to the reflective facets 66. The position where the laser beam 50 is applied to the irradiated facet 66A is thus adjusted with respect to each of the reflective facets 66 (the laser beam applying step S4).

One of the reflective facets 66 of the polygon mirror 64 has been described above as being established as the detectable facet 66B. However, the polygon mirror 64 is limited to such a configuration. Rather than establishing the detectable facet 66B on the polygon mirror 64, the polygon mirror 64 may be configured such that all the reflective facets 66 have different reflective properties, i.e., different reflectances, for example. According to this modification, the light detecting unit 124 detects different amounts of light reflected from the respective reflective facets 66 when they are irradiated with the light 122a. Therefore, the specifying section 48a can specify the reflective facet 66a irradiated with the light 122a, on the basis of the amount of light detected by the light detecting unit 124.

The structural and methodical details of the above embodiment may be changed or modified without departing from the scope of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a laser oscillator for emitting a laser beam;
a polygon mirror having a plurality of reflective facets and rotatable for scanning the laser beam;
a beam condenser for focusing the laser beam scanned by the polygon mirror;
a position adjusting unit for adjusting irradiated positions where the reflective facets are irradiated with the laser beam; and
a measuring unit for measuring the positions of irradiated regions that are irradiated with the laser beam scanned by the polygon mirror, wherein
the position adjusting unit adjusts the irradiated positions where the reflective facets are irradiated with the laser beam with respect to the respective reflective facets on a basis of the positions of the irradiated regions measured by the measuring unit with respect to the respective reflective facets.

2. A laser beam applying method of applying a laser beam to a plurality of reflective facets of a polygon mirror, comprising:
measuring positions of irradiated regions that are irradiated with the laser beam scanned by the polygon mirror with respect to the respective reflective facets; and
while the laser beam is being applied to the reflective facets, adjusting irradiated positions where the reflective facets are irradiated with the laser beam with respect to the respective reflective facets on a basis of the positions of the irradiated regions, which have been measured in the measuring.
